(19) United States
(12) Patent Application Publication
(10) Pub. No.: US 2017/0172156 A1
(43) Pub. Date: Jun. 22, 2017

(54) Semi-Moldable Animal Attractant Lure

(71) Applicant: Christopher Eugene Funk, Strasburg, VA (US)

(72) Inventor: Christopher Eugene Funk, Strasburg, VA (US)

(21) Appl. No.: 14/970,623

(22) Filed: Dec. 16, 2015

(51) Int. Cl. A01N 63/02; A01M 31/06; A01M 31/00; A01N 25/10

(52) U.S. Cl. CPC A01N 63/02; A01N 25/10; A01M 31/06; A01M 31/008

(57) ABSTRACT

Animal-attractant lure compound includes a semi-solid moldable compound having an elastic consistency, said mass including a silicone polymer material that includes a viscoelastic liquid. The compound is capable of being selectively adhered to environmental structure to which it is applied. The compound may include an animal-attractant scent impregnated therein or applied by a hunter. The compound may be a polysiloxane.

### BACKGROUND OF THE INVENTION

This invention relates generally to animal scent compounds and, more particularly, to an animal attractant lure that adheres to environmental objects with minimal human action or components so as to present a deer-urine scent into an outdoor area.

Deer urine is frequently used in the process of hunting for deer. Specifically, the role of deer urine is to attract deer to pass within a reasonable distance of where the hunter intends to be personally located in his effort to harvest the deer, e.g. to take a shot. Of course, the hunter needs to scout the area for evidence of the presence of deer before assuming that spreading deer urine will magically bring deer into an area, e.g. looking for trails, scrapes, rubs, bedding and feeding areas. Determining wind patterns is also an important part of luring a deer into a “kill zone.”

Deer urine is introduced into an outdoor environment in several ways, such as hanging scent canisters from tree limbs, spraying scent from a bottle, dropping a path of scent pellets, or even tying a urine-soaked rag to his boot while walking a deer trail. With the numerous and potentially time consuming preparations made by a deer hunter, it would be advantageous if a deer urine luring compound could be spread about a kill zone without the time-consuming and inconvenient steps of hanging multiple urine packages, spraying urine scent from a bottle, or other inconvenient methods.

Therefore, it would be desirable to have animal-attractant lure compound having an elastic or doughy configuration that may be smeared and adhered onto environmental objects within a kill zone, such as on trees, fence posts, bushes, grass, or the like. Further, it would be desirable to have animal-attractant lure compound that may be smeared on the hunter's boot so as to be spread along a deer trail as the hunter walks to his deer stand.

### SUMMARY OF THE INVENTION

Animal-attractant lure compound according to the present invention includes a semi-solid moldable compound having an elastic consistency, said mass including a silicone polymer material that includes a viscoelastic liquid. The compound is capable of being selectively adhered to environmental structure to which it is applied. The compound may include an animal-attractant scent impregnated therein or applied by a hunter. The compound may be a polysiloxane. Alternatively, the compound may include no attractant (i.e. no scent) but may receive an attractant later by a hunter's own application. For instance, the scent of the animal being hunted may vary from hunting trip to hunting trip.

Therefore, a general object of this invention is to provide an animal-attractant lure compound that may be applied to environmental structures in a kill-zone with minimal effort by a hunter.

Another object of this invention is to provide an animal-attractant lure compound, as aforesaid, having a moldable and adhesive construction that may be smeared, applied, and adhered to environmental objects within a deer kill-zone, including on tree trunks, flora, or man-made objects.

Still another object of this invention is to provide an animal-attractant lure compound, as aforesaid, that is selectively adhered to a hunter's shoe so that urine, when applied to the compound, is deposited on surfaces upon which the hunter walks.

Yet another object of this invention is to provide an animal-attractant lure compound, as aforesaid, in which the lure compound has a doughy or putty-like consistency that may at first be packaged but then easily removed, torn into pieces, and adhered to environmental objects within a kill-zone.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of animal-attractant lure according to a preferred embodiment of the present invention;

FIG. 2a is another perspective view of the lure as in FIG. 1, illustrated applied to a post;

FIG. 2b is perspective view from another angle of the lure as in FIG. 2a;

FIG. 3a is a bottom perspective view of the lure applied to a boot;

FIG. 3b is a side view of the boot and lure as in FIG. 3a;

FIG. 4a is perspective view of the lure as in FIG. 1, illustrated applied to a stalk of a tree or bush; and

FIG. 4b is an isolated view on an enlarged scale taken from FIG. 4a.

### DESCRIPTION OF THE PREFERRED EMBODIMENT

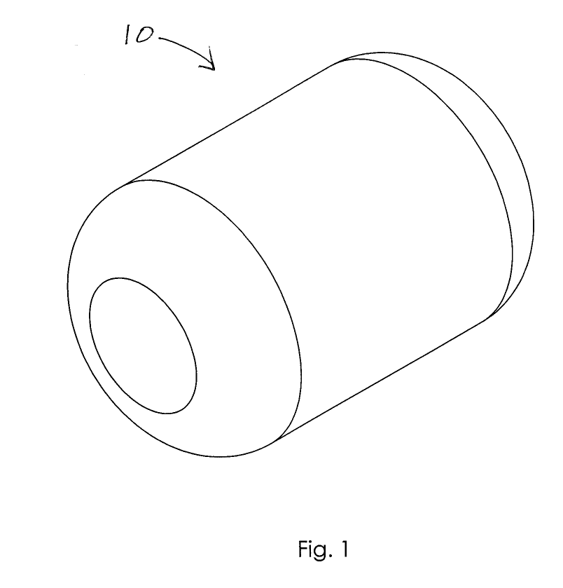

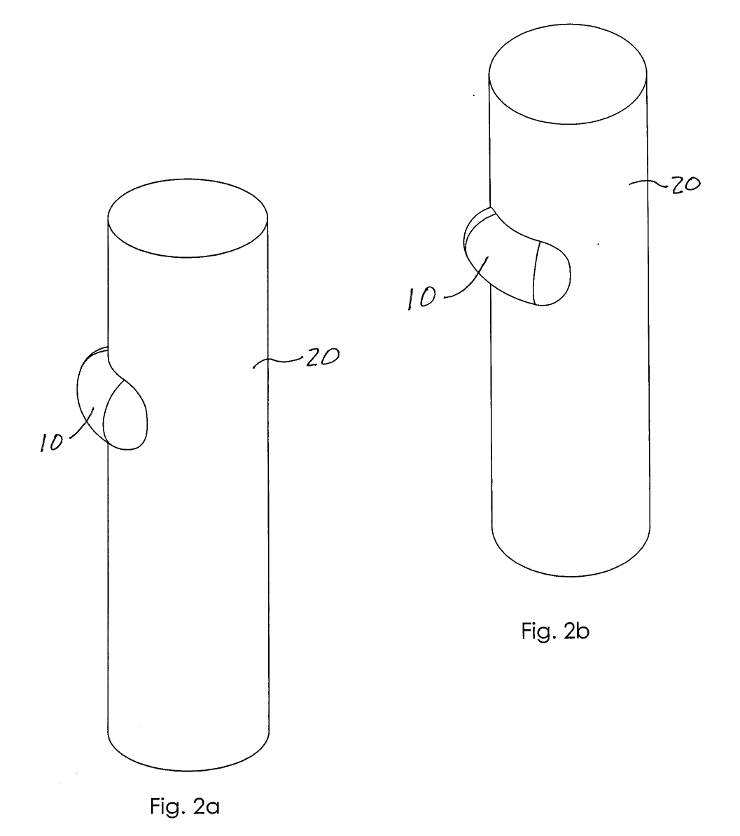

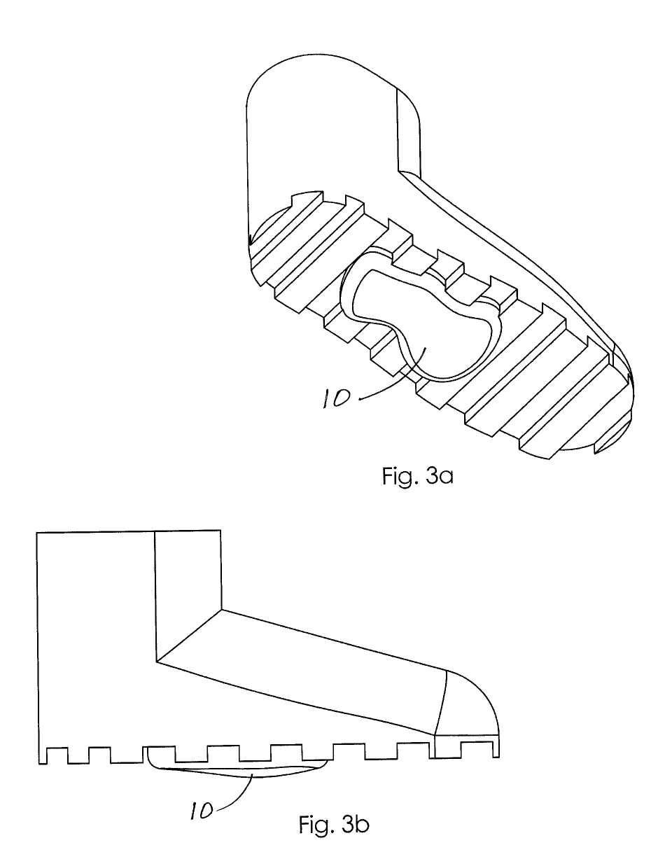

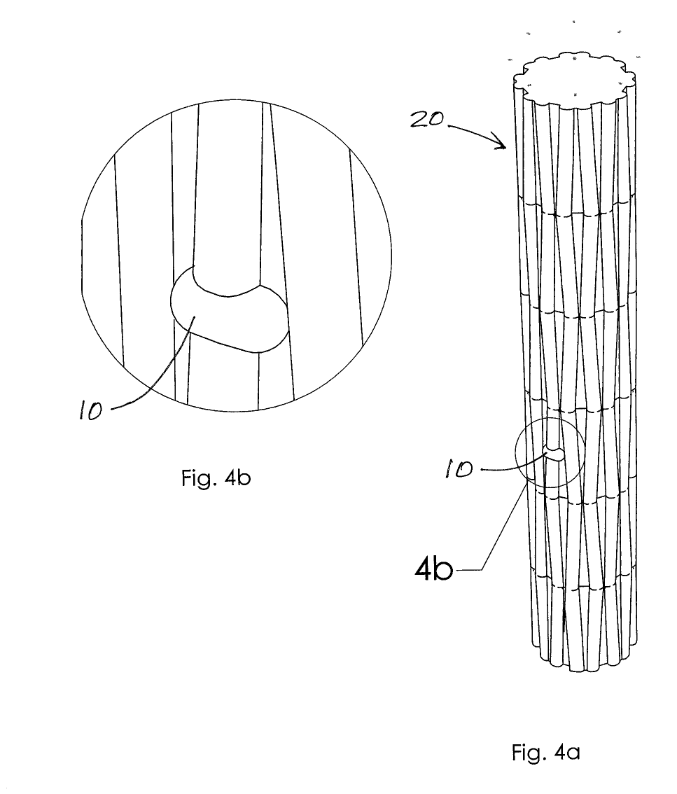

A semi-moldable animal-attractant lure according to a preferred embodiment of the present invention will now be described with reference to FIGS. 1 to 4b of the accompanying drawings.

The animal-luring compound includes a moldable compound 10 having an elastic consistency capable of being adhered to environmental structures 20. Specifically, the moldable compound 10 is composed of a polymer material having viscoelastic and adhesive properties. Viscoelasticity is the property of materials that exhibit both viscous and elastic characteristics when undergoing deformation. In an embodiment, the moldable compound 10 is a polysiloxane. A polysiloxane is one of the most important organosilicon polymers. Polysiloxanes are known for their useful properties such as flexibility, being hydrophobic (water repellant), and generally impermeable to particles (i.e. a good protective coating). Viscoelastic refers to

In an embodiment, the polymeric compound may be selected from a group consisting of amorphous polymers, semi-crystalline polymers, and biopolymers. Polymers exhibit two types of morphology in the solid state; amorphous and semicrystalline. In an amorphous polymer the molecules are oriented randomly and are intertwined. In semicrystalline polymers, the molecules pack together in ordered regions called crystallites. Biopolymers are polymers produced by living organisms; in other words, they are polymeric biomolecules. Since they are polymers, biopolymers contain monomeric units that are covalently bonded to form larger structures. Cellulose is the most common organic compound and biopolymer on Earth.

The moldable compound 10 may be in the form of putty that may be smeared onto environmental structures. Environmental structures 20 to which the moldable compound may be adhered are taken from a group consisting of a hunter's apparel, tree bark, grass, and the ground. Preferably, a hunter will smear portions of a quantity of the moldable compound onto trees, grass, bushes, fence posts, and the like along a path. More particularly, a hunter may adhere quantities of the moldable compound 10 about 200 yards from the hunter's position as that is a preferable distance to shoot a deer attracted to the scent.

The animal-luring compound may include an animal attractant. In an embodiment, the animal attractant may be a deer attractant such as deer urine or human urine. The deer urine may be a formulation indicative of urine taken from a female deer or from a male deer. In one embodiment, the moldable compound 10 may be impregnated with the attractant at a point of manufacturing. Alternatively, the moldable compound 10 may include a liquid coating of an attractant such as urine applied after the time of manufacturing or even applied by a hunter before adhering the moldable compound to an environmental structure 20.

In use, the moldable compound of an animal-luring compound may be packaged in the form of an elastic pellet. In fact, multiple moldable compounds may be included in a single package. In one embodiment, each moldable compound may be originally impregnated with a particular deer attractant during manufacturing, such as deer urine. A moldable compound has a shapeable and elastic consistency like putty so that a hunter can smear portions thereof on tree trunks or limbs or even on his own shoes or clothing when walking a trail into the woods to a hunting location.

It is understood that while certain forms of this invention have been illustrated and described, it is not limited thereto except insofar as such limitations are included in the following claims and allowable functional equivalents thereof.

1. An animal-luring compound comprising:
a moldable compound having an elastic consistency capable of being adhered to environmental structure, said compound being impregnated with an animal attractant;
wherein said compound exhibits non-linear viscoelastic properties.

2. The compound of claim 1, wherein said compound is selected from the group consisting of amorphous polymers, semi-crystalline polymers, and biopolymers.

3. The compound of claim 1, wherein said compound is a polysiloxane.

4. The compound of claim 3, wherein said animal attractant is a deer attractant.

5. The compound of claim 4, wherein said deer attractant is human urine.

6. The compound of claim 4, wherein said deer attractant is deer urine.

7. The compound of claim 6, wherein the urine is from a female deer.

8. The compound of claim 6, wherein the urine is from a male deer.

9. An animal-luring compound comprising:
a semi-solid moldable compound having an elastic consistency capable of being adhered to environmental structure, said compound being impregnated with a deer attractant;
wherein said compound is a polysiloxane.

10. The compound of claim 9, wherein said deer attractant is at least one of human urine and deer urine.

11. The compound of claim 10, wherein said attractant is urine from a female deer.

12. The compound of claim 10, wherein said attractant is urine from a male deer.

13. The compound of claim 11, wherein said environmental structure is selected from the group consisting of a hunter's apparel, tree bark, grass, and the ground.

14. The compound of claim 13, wherein said environmental structure is located within 200 yards of a structure for concealing the hunter's position.

15. The compound of claim 14, wherein the compound is further adhered to said structure for concealing the hunter's position.

16. The compound of claim 13, wherein said compound is selectively adhered to said environmental structure along a trail.

17. A method for luring an animal, comprising:
providing a semi-solid moldable compound exhibiting elastic and adhesive properties capable of being adhered to environmental structure;
adhering said moldable compound to said environment structure.

18. The method as in claim 17, wherein said compound is a polysiloxane.

19. The method as in claim 18, further comprising impregnating said compound with a deer attractant.

20. The method as in claim 18, wherein said deer attractant is deer urine.
